(19) United States
(12) Patent Application Publication
(10) Pub. No.: US 2003/0058849 A1
(43) Pub. Date: Mar. 27, 2003

(54) Telecommunication system with distributed broadband remote

(75) Inventor: Ivan Anton Verbesselt, Londerzeel (BE)

Correspondence Address: SUGHRUE MION, PLLC, 2100 Pennsylvania Avenue, N.W., Washington, DC, 20037-3213, US

(73) Assignee: ALCATEL

(21) Appl. No.: 10/234,127

(22) Filed: Sep. 5, 2002

(30) Foreign Application Priority Data
Sep. 26, 2001 (EP) 01402462.4

(51) Int. Cl. H04L 12/56

(52) U.S. Cl. 370/386; 370/401

(57) ABSTRACT

A telecommunication system comprising an access network (EDGE) to which a plurality of subscribers (USERS) are coupled, interconnected with a core network (CORE) to which several network service providers (NSP) are coupled. The system further comprises a primary tier broadband remote access server (T1_BRAS) interfacing the access and the core networks, and a secondary tier broadband remote access server (T2_BRAS) located closer to the subscribers. In this system, when subscribers want to be connected to service providers, the secondary tier server sends (S1) the upstream traffic from the subscribers towards the primary tier server. The primary tier server then classifies these incoming flows into session aggregations on basis of a local algorithm. Finally, the primary tier server signals (S2) to the secondary tier server to aggregate predetermined incoming flows into communication pipes according to the session aggregations. According to the present method, the primary tier server imposes an aggregation specification onto the secondary tier server. This aggregation specification specifies local rules to be applied by the secondary tier server to instances of the session aggregations. The access network (EDGE) preferably uses label switching [L2] technology between the primary and the secondary tier servers.

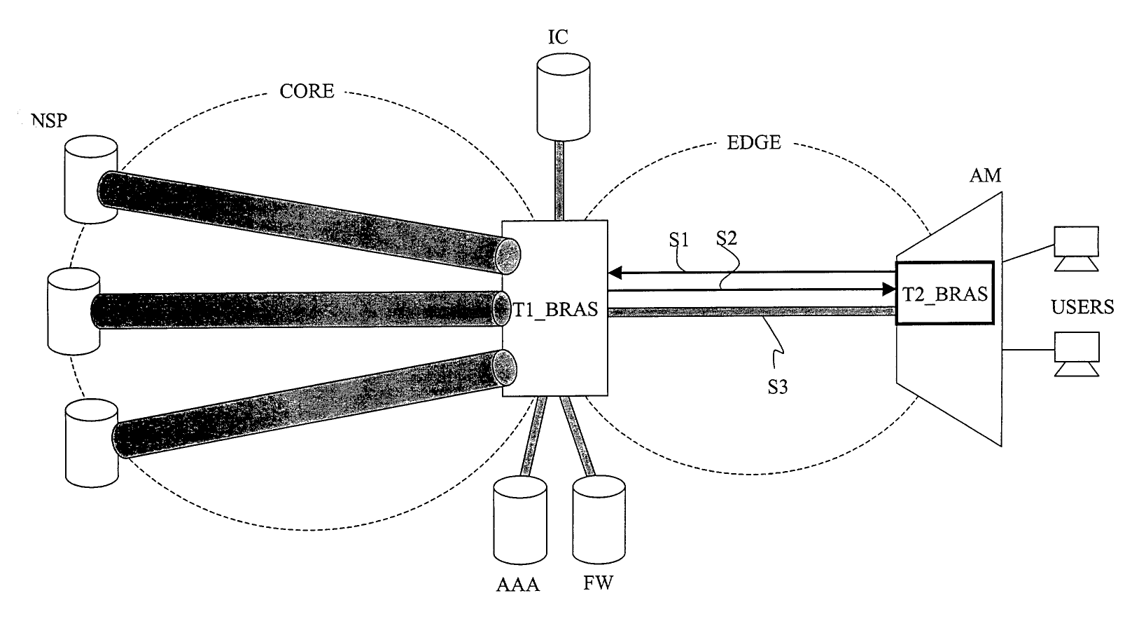

The present invention relates to a telecommunication system comprising an access network to which a plurality of subscribers are coupled, a core network coupled to said access network and to which a plurality of network service providers are coupled, and a broadband remote access server adapted to connect said subscribers to said network service providers via said access network and said core network, said broadband remote access server being further adapted to aggregate connections from subscribers towards said network service providers into a concentrated communication pipes.

Such a telecommunication system is already known in the art. Broadband Remote Access Servers [BRAS] have been introduced in end-to-end service delivery systems to enhance the scaleability of broadband access deployments, e.g. for Digital Subscriber Lines [DSL]. The main services provided by these servers are as follows:

allow for a flexible service selection by the end user or subscriber towards network service providers;

increase the scaleability of the system by providing session aggregation into relatively bigger concentrated pipes towards the network service providers;

be a flexible interface between the access network, generally operating in Asynchronous Transfer Mode [ATM], and data backbones of operators; and

be a flexible wholesale access point between Network Access Providers [NAP] coupled to the server and Network Service Providers [NSP].

Meanwhile, a number of evolutions are gradually changing the scaleability constraints and hence increasingly stressing the above session aggregation. This is a result of an increasing port density at the NAP's side and of an increasing uptake of required services.

Both constraints are currently driving the service deployment, and thus the broadband remote access server, deeper into the network, i.e. closer to the subscriber. The ultimate case being the integration of the functionality of the broadband remote access server into the access node interconnecting the access network and the subscribers.

As a result of such a deployment, broadband remote access servers are no longer maintained into a confined geographical portion of the access network, which poses a significant scaleability problem. The cost-of-ownership will for instance be increased because of the necessity of operating more complex devices deeper in the network.

Additionally, today's broadband remote access server implementations are addressing considerably more functionality than strictly needed for addressing the initial objective of scaleability through aggregation. Typically, a value-added functionality, such as intelligent caching, firewalling, Authentication-Authorization-Accounting [AAA], associated to the broadband remote access server, is preferably dealt with as high as possible in the network. This is a consequence of the significant amount of control and management it requires. In addition, deploying the value-added functionality at a higher level in the network allows for some interesting economies of scale.

An object of the present invention is to provide a telecommunication system of the above known type but wherein the broadband remote access server is adapted to achieve the required services and value-added functionality while remaining relatively economic and simple to implement.

According to the invention, this object is achieved due to the fact that said broadband remote access server includes:

a primary tier broadband remote access server (T1_BRAS) interfacing said access network (EDGE) with said core network (CORE) and adapted to aggregate, in said core network, connections from said primary tier broadband remote access server towards network service providers (NSP) into distinct first communication pipes, and

a secondary tier broadband remote access server (T2_BRAS) located relatively close to said subscribers and adapted to aggregate, in said access network, connections from subscribers towards said primary tier server into second concentrated communication pipes.

The aggregation function of the secondary tier broadband remote access server, located relatively deep in the network, relieves the connection burden on the access node, which is even exacerbated due to the moving of the primary tier broadband remote access server higher in the network. This further allows the primary tier broadband remote access server to be more scaleable and deployable. Moreover, the primary and secondary tier broadband remote access servers collaborate such as to aggregate sessions in such a way that the same functionality is offered as from a known ‘monolithic’ broadband remote access server. The invention relies thus on a multi-tier network topology where the different components of the broadband remote access server's functionality can be flexibly shifted in the network and collaborate to achieve dynamic aggregation. This further allows to decrease cost-of-ownership and management complexity since the added value functionality (caching, fire-walling, AAA, . . . ) of the primary tier broadband remote access server is dealt with as high as possible in the network.

Another characterizing embodiment of the present invention is that said access network is adapted to use label switching [L2] technology between said primary tier server and said secondary tier server.

The label switching technology corresponds for instance to Layer 2 [L2] connections of the OSI model. This technology allows the telecommunication system to operate according to protocols such as Asynchronous Transfer Mode [ATM], Frame Relay [FR], Multi Path Line Switching [MPLS], Tag Switching, . . .

Also another characterizing embodiment of the present invention is that said telecommunication system further includes an access multiplexer adapted to interconnect subscribers to said access network, and that said secondary tier server is integrated into said access multiplexer.

In this way, the access multiplexer, which preferably is a digital subscriber line access multiplexer [DSLAM], becomes an access node upgraded to provide the above-mentioned services and value-added functionality.

The present invention also relates to a method to establish telecommunication connections between subscribers coupled to an access network and network service providers coupled to a core network, said core network being coupled to said access network, and said method consisting in establishing said connections via a broadband remote access server adapted to aggregate connections from said subscribers towards said network service providers into concentrated communication pipes.

Such a telecommunication system is already known in the art as mentioned above, and the connection method used therein consists in providing session aggregations into concentrated pipes between the broadband remote access server and the network service providers.

A second object of the present invention is to provide an improved method for transmitting data through the telecommunication system via the broadband remote access server.

According to the invention, this second object is achieved due to the fact that said broadband remote access server comprises a primary tier broadband remote access server interfacing said access network and said core network and adapted to aggregate, in said core network, connections from said primary tier broadband remote access server towards network service providers into distinct first communication pipes, and a secondary tier broadband remote access server located relatively close to said subscribers and adapted to aggregate, in said access network, connections from subscribers towards said primary tier server into second concentrated communication pipes, and that said method further consists in:

said secondary tier server sending all upstream traffic from said subscribers towards said primary tier server;

said primary tier server classifying the incoming flows of said upstream traffic into session aggregations on basis of a local algorithm;

said primary tier server signaling to said secondary tier server to aggregate predetermined incoming flows into second communication pipes according to said session aggregations.

In this way, the flows are arranged in session aggregations from the subscriber to the network service provider via the two cooperating tier servers.

Another characterizing embodiment of the present method is that a label switching [L2] technology is used between said secondary tier server and said primary tier server through said access network, that said secondary tier server sends said upstream traffic towards said primary tier server onto a default label, and that said primary tier server relies on the signaling plane of said label switching technology to signal to said secondary tier server to forward predetermined incoming flows onto newly established or pre-provisioned label connections associated to said session aggregations.

Certain flows can thus be shifted to dedicated label connections according to different criteria's.

Also another characterizing embodiment of the present method is that said secondary tier server is adapted to classify downstream traffic from said primary tier server towards said subscribers into session aggregations on basis of a second local algorithm.

The resulting redirections action for the downstream traffic need not be identical to the redirection action performed on the upstream traffic.

Further characterizing embodiments of the present telecommunication system with distributed broadband remote access servers are mentioned in the appended claims.

It is to be noticed that the term ‘comprising’, used in the claims, should not be interpreted as being restricted to the means listed thereafter. Thus, the scope of the expression ‘a device comprising means A and B’ should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

The above and other objects and features of the invention will become more apparent and the invention itself will be best understood by referring to the following description of an embodiment taken in conjunction with the accompanying drawings wherein the figure represents a telecommunication system with distributed broadband remote access servers T1_BRAS and T2_BRAS according to the invention.

The telecommunication system shown at the figure comprises an access network EDGE interconnected to a core network CORE via a primary tier broadband remote access server T1_BRAS. A plurality of subscribers USERS are coupled to the access network via an access multiplexer AM which is for instance a digital subscriber line access multiplexer [DSLAM]. This access multiplexer AM is associated to or embeds the functions of a secondary tier broadband remote access server T2_BRAS. The access multiplexer AM can thus be seem as being an access aggregation node. In other words, the secondary tier broadband remote access server T2_BRAS can be seen as integrated into the access multiplexer AM. A plurality of network service providers NSP are coupled to the core network, and the broadband remote access servers T1_BRAS and T2_BRAS are adapted to connect the subscribers USERS to these network service providers.

In the core network CORE, the primary tier broadband remote access server T1_BRAS is adapted to aggregate connections from the subscribers towards the network service providers NPS into concentrated communication pipes whilst, in the access network EDGE, the secondary tier broadband remote access server T2_BRAS, located closer to the subscribers USER, is adapted to aggregate connections from these subscribers towards the primary tier server T1_BRAS into second concentrated communication pipes. The upstream connections from the subscribers USER, i.e. originated from a Customer Premises Equipment [CPE], aggregated by the secondary tier server T2_BRAS into the second communication pipes through the access network EDGE, are aggregated by the primary tier server T1_BRAS into bigger concentrated pipes towards the providers NPS through the core network CORE. The primary and secondary tier servers collaborate such as to aggregate sessions in such a way that the same functionality is offered as from a ‘monolithic’ broadband remote access server (BRAS).

The telecommunication system relies on a multi-tier network topology where different components of the value-added BRAS functionality, such as intelligent caching IC, firewalling FW, Authentication-Authorization-Accounting AAA, can be flexibly shifted in the network and collaborate in order to achieve dynamic aggregation.

It is further assumed that a [L2] label switching technology, e.g. Asynchronous Transfer Mode [ATM], Frame Relay [FR], Multi Path Line Switching [MPLS] or Tag Switching, is available between the tier servers T1_BRAS and T2_BRAS. The operation of the primary tier T1_BRAS and secondary tier T2_BRAS broadband remote access servers is as follows.

All upstream traffic from a subscriber USER, i.e. a user session, is by default sent towards the primary tier server T1_BRAS onto a default label “Ld” by the secondary tier server T2_BRAS. This transmission is indicated by S1 on the figure.

The primary tier server T1_BRAS classifies the incoming flows carried on basis of a local algorithm. Such a local algorithm is for instance the successful completion of a “PPP” session establishment either through local AAA or through proxy AAA, or of a “PPP” session establishment through “L2TP” tunneling, or through other in-band or out-of-band session establishment or service selection mechanisms.

The primary tier server T1_BRAS then relies on the control plane of the label switching technology between T1_BRAS and T2_BRAS, as indicated by S2, to signal to the secondary tier server T2_BRAS that it has to forward some selected flows onto newly established or pre-provisioned label connections, indicated by S3 on the figure.

It is to be noted that the mechanisms for establishing the [L2] label switched connection are dependent on the [L2] label switching technology used and are beyond the scope of this invention.

In the above method, the criteria to shift certain flows to dedicated label connections can be manifold. Some examples are given below:

all traffic to be forwarded from the primary tier server T1_BRAS to a predetermined network service provider NSP;

all traffic to be forwarded to a predetermined network service provider NSP with a given traffic/QoS (Quality-of-Service) profile or a given service specification;

all traffic entitled to certain packages of value-add processing, e.g. intelligent caching IC, fire-walling FW or Authentication-Authorization-Accounting AAA; and/or

all traffic with predetermined service attributes, e.g. voice or data.

Once a user session is added to such a dedicated or aggregated label connection, the primary tier server T1_BRAS has the ability to flexibly invoke its value-add functionality, e.g. caching, fire-walling, . . . , for the different aggregated flows. In fact, the aggregated flows can be cut-through to dedicated companion servers in the primary tier server T1_BRAS realm without relying on the store-and-forward engines of the primary tier server T1_BRAS.

As an example, user sessions aggregated into flows that are not entitled to value-add post-processing can immediately be cut-through to a network service provider NSP, e.g. a Virtual Private Network [VPN] service provider, without posing an additional burden onto the store-and-forward engines of the primary tier server T1_BRAS.

Optionally, the secondary tier server T2_BRAS can autonomously perform the same redirection action for the downstream traffic. This aggregation need not be identical.

While the components of the broadband remote access servers T1_BRAS and T2_BRAS can rely on the control plane offered by the [L2] label switching platform to signal the desired aggregation, some extensions have be made to the latter in order to truly accommodate the Broadband Remote Access Servers or BRAS functional segregation. One such an example is aggregation security. Indeed, once user sessions have been associated to ‘aggregated flows’, e.g. as per AAA mechanisms as referred to above, security issues might arise since users could perform address spoofing within the same aggregated flow. This can for instance be achieved by picking another [L3] address out of the VPN field associated to the network service provider NSP and by performing a Denial of Service [DOS] attack on the spoofed address. The latter is typically prohibited in monolithic broadband remote access servers that always check the association between the [L3] address and the [L2] user label prior to forwarding on a per packet basis. In order for a segregated BRAS model, according to the present invention, to exhibit the same level of security, this behavior will have to be addressed at the aggregation point, i.e. by the secondary tier server T2_BRAS. The solution is to have the primary tier server T1_BRAS imposing an ‘aggregation specification’ onto the secondary tier server T2_BRAS thus enforcing the same aggregation rules to be applied on a per packet basis, irrespective of where the aggregation function actually takes place. This has the advantage of having the same level of control and ease of management as with the monolithic broadband remote access servers, without being forced to manage the secondary tier servers T2_BRAS very extensively, if at all.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is made only by way of example and not as a limitation on the scope of the invention, as defined in the appended claims.

1. A telecommunication system comprising an access network (EDGE) to which a plurality of subscribers (USERS) are coupled, a core network (CORE) coupled to said access network and to which a plurality of network service providers (NSP) are coupled, and a broadband remote access server (T1_BRAS; T2_BRAS) adapted to connect said subscribers to said network service providers via said access network and said core network,
said broadband remote access server being further adapted to aggregate connections from subscribers towards said network service providers into concentrated communication pipes,
characterized in that said broadband remote access server includes:
a primary tier broadband remote access server (T1_BRAS) interfacing said access network (EDGE) with said core network (CORE) and adapted to aggregate, in said core network, connections from said primary tier broadband remote access server towards network service providers (NSP) into distinct first communication pipes, and
a secondary tier broadband remote access server (T2_BRAS) located relatively close to said subscribers and adapted to aggregate, in said access network, connections from subscribers towards said primary tier server into second concentrated communication pipes.

2. The telecommunication system according to claim 1, characterized in that said access network (EDGE) is adapted to use label switching [L2] technology between said primary tier server (T1_BRAS) and said secondary tier server (T2_BRAS).

3. The telecommunication system according to claim 1,
characterized in that said telecommunication system further includes an access multiplexer (AM) adapted to interconnect subscribers (USERS) to said access network (EDGE),
and in that said secondary tier server (T2_BRAS) is integrated into said access multiplexer.

4. The telecommunication system according to claim 3, characterized in that functions of said secondary tier server (T2_BRAS) are embedded into said access multiplexer (AM) which is an access aggregation node.

5. The telecommunication system according to claim 3, characterized in that said access multiplexer (AM) is a digital subscriber line access multiplexer [DSLAM].

6. The telecommunication system according to claim 1, characterized in that said primary broadband remote access server (T1_BRAS) further includes added value functionality, such as firewalling functionality or intelligent caching functionality.

7. A method to establish telecommunication connections between subscribers (USERS) coupled to an access network (EDGE) and network service providers (NSP) coupled to a core network (CORE), said core network being coupled to said access network, and said method consisting in establishing said connections via a broadband remote access server (T1_BRAS, T2_BRAS) adapted to aggregate connections from said subscribers towards said network service providers into concentrated communication pipes,
characterized in that said broadband remote access server comprises a primary tier broadband remote access server (T1_BRAS) interfacing said access network (EDGE) and said core network (CORE) and adapted to aggregate, in said core network, connections from said primary tier broadband remote access server towards network service providers (NSP) into distinct first communication pipes, and a secondary tier broadband remote access server (T2_BRAS) located relatively close to said subscribers and adapted to aggregate, in said access network, connections from subscribers towards said primary tier server into second concentrated communication pipes,
and in that said method further consists in:
said secondary tier server sending (S1) all upstream traffic from said subscribers towards said primary tier server;
said primary tier server classifying the incoming flows of said upstream traffic into session aggregations on basis of a local algorithm;
said primary tier server signaling (S2) to said secondary tier server to aggregate predetermined incoming flows into second communication pipes according to said session aggregations.

8. The method according to claim 7, characterized
in that a label switching [L2] technology is used between said secondary tier server (T2_BRAS) and said primary tier server (T1_BRAS) through said access network (EDGE),
in that said secondary tier server sends said upstream traffic towards said primary tier server onto a default label (Ld),
and in that said primary tier server relies on the signaling plane of said label switching technology to signal to said secondary tier server to forward predetermined incoming flows onto newly established or pre-provisioned label connections associated to said session aggregations.

9. The method according to claim 7, characterized in that said secondary tier server (T2_BRAS) is adapted to classify downstream traffic from said primary tier server towards said subscribers into session aggregations on basis of a second local algorithm.

10. The method according to claim 8, characterized in that said primary tier server (T1_BRAS) imposes an aggregation specification onto said secondary tier server (T2_BRAS), said aggregation specification specifying local rules to be applied by said secondary tier server to instances of said session aggregations.

11. The method according to claim 8, characterized in that said session aggregations correspond to dedicated label connections.
